(19) United States
(12) Patent Application Publication
(10) Pub. No.: US 2015/0046846 A1
(43) Pub. Date: Feb. 12, 2015

(54) APPARATUS AND METHOD FOR SHARING INFORMATION IN TERMINAL

(71) Applicant: Samsung Electronics Co., Ltd., Gyeonggi-do (KR)

(72) Inventors: Bo Kun CHOI, Seoul (KR); Geon Soo KIM, Gyeonggi-do (KR); Han Jib KIM, Gyeonggi-do (KR); Jin Hong JEONG, Gyeonggi-do (KR); Jae Sung KU, Gyeonggi-do (KR)

(21) Appl. No.: 14/452,672

(22) Filed: Aug. 6, 2014

(30) Foreign Application Priority Data
Aug. 9, 2013 (KR) 10-2013-0094590

(51) Int. Cl. H04L 29/06; G06F 3/0482; G06F 3/0481; H04W 4/00; H04M 1/725

(52) U.S. Cl. CPC H04L 65/403; H04W 4/005; H04M 1/72583; G06F 3/04817; G06F 3/0482
USPC 715/753

(57) ABSTRACT

An apparatus and a method for sharing information in a terminal are disclosed. At least one application is selected and sharing information including an icon and an identifier associated with the selected application is generated. The generated sharing information is transmitted to at least another terminal.

### CLAIM OF PRIORITY

This application claims the benefit under 35 U.S.C. §119(a) of a Korean patent application filed on Aug. 9, 2013 in the Korean Intellectual Property Office and assigned Serial No. 10-2013-0094590, the entire disclosure of which is incorporated by reference herein.

### TECHNICAL FIELD

The present disclosure relates to an apparatus and a method for sharing information and, more particularly, to an apparatus and a method for sharing information between different terminals, which can increase the usability of the shared data.

### BACKGROUND

Diverse use patterns and configurations of portable terminals have recently developed due to an increase in the number and type of applications supporting portable terminals. In accordance with this trend, use patterns cannot be easily categorized as business, housework, and hobbies, since every person uses the portable terminal differently. Therefore, use patterns of portable terminals can no longer be predicted based on user requirements and user personalities, since users now utilize their portable terminals in creative ways.

In addition, users are increasingly sharing their usage experiences. In current application store (“App store”) environments, an application download may be recommended based on the use pattern or download propensity of a terminal user. However, these services are not practical; moreover, some users are even not aware of such services provided by the portable terminal.

Therefore, a method of sharing information or applications more conveniently is desirable.

### SUMMARY

In view of the foregoing, disclosed herein are an apparatus and method for sharing information with a portable terminal and, particularly, for dynamically generating application sharing information or setting information and increasing the usability of shared data in the terminal.

In accordance with an aspect of the present disclosure, a method for sharing information in a terminal is disclosed. The method may include selecting at least one application; generating sharing information including an icon and an identifier associated with the selected application; and transmitting the generated sharing information to at least another terminal.

In accordance with another aspect of the present disclosure, an apparatus for sharing information in a terminal is disclosed. The apparatus may include at least one processor to exchange data with another terminal using a communication unit; select at least one application; generate sharing information including an icon and an identifier associated with the selected application; and transmit the generated sharing information to at least one other terminal.

In accordance with a further aspect of the present disclosure, a method for sharing information in a terminal is disclosed. The method may include receiving sharing information of at least one application from another terminal; generating a configuration file corresponding to the sharing information; displaying a dummy icon corresponding to the configuration file; and transmitting a request for application installation information corresponding to an identifier included in the configuration file, when the dummy icon is selected.

In accordance with yet another aspect of the present disclosure, an apparatus for sharing information in a terminal is disclosed. The apparatus may include at least one processor to: exchange data with another terminal and an application download server; display at least one icon and an operating state; detect receipt of sharing information for at least one application from another terminal; generate a configuration file corresponding to the sharing information; display a dummy icon corresponding to the configuration file; and request installation of an application corresponding to an identifier included in the configuration file, when the dummy icon is selected.

### BRIEF DESCRIPTION OF THE DRAWINGS

The above and other aspects, features, and advantages of certain examples of the present disclosure will be more apparent from the following description taken in conjunction with the accompanying drawings, in which:

FIG. 1 is a block diagram illustrating an example information sharing system in accordance with aspects of the present disclosure;

FIG. 2 is a block diagram illustrating an example configuration of a terminal in accordance with aspects of the present disclosure;

FIG. 3 is a flow chart illustrating an example information sharing method by using a message in accordance with aspects of the present disclosure;

FIG. 4 is a flow chart illustrating an example method for sharing information of an application in accordance with aspects of the present disclosure;

FIG. 5 is a flow chart illustrating another example method for sharing an application in accordance with aspects of the present disclosure;

FIG. 6 is a flow chart illustrating an example method in a first terminal in accordance with aspects of the present disclosure;

FIG. 7 is a flow chart illustrating an example method in a second terminal in accordance with aspects of the present disclosure;

FIG. 8 is a flow chart illustrating an example method of installing an application in accordance with aspects of the present disclosure;

FIG. 9A and FIG. 9B show an example screen in accordance with aspects of the present disclosure;

FIG. 10 is a flow chart illustrating an example method for executing an application in accordance with aspects of the present disclosure; and

FIG. 11 is a flow chart illustrating an example method of sharing setting information in accordance with aspects of the present disclosure.

### DETAILED DESCRIPTION

Hereinafter, examples of the disclosure are described in detail with reference to the accompanying drawings. The same reference symbols are used throughout the drawings to refer to the same or like parts. Detailed descriptions of well-known functions and structures incorporated herein may be omitted to avoid obscuring the subject matter of the disclosure.

In the present disclosure, it is to be understood that the form “a portion includes a component” doesn't mean excluding other components unless the context clearly dictates otherwise and may further include any other component not listed therein.

Hereinafter, examples of the present disclosure are described in more detail referring to the accompanying drawings.

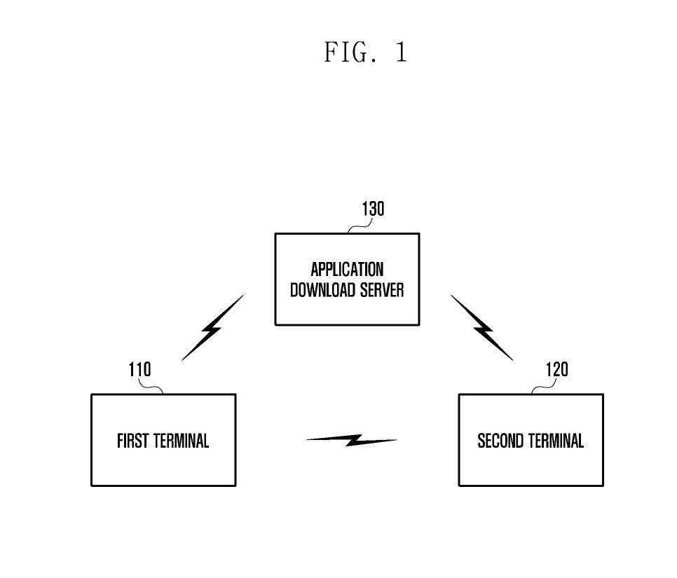

FIG. 1 is a block diagram illustrating an information sharing system in accordance with aspects of the present disclosure. An information sharing system may include a first terminal 110 and a second terminal 120. The terminals 110 and 120 may be electronic equipment capable of information sharing, and may include a smart phone, portable terminal, mobile terminal, PDA (Personal Digital Assistant), PMP (Portable Multimedia Player), notepad, Wibro terminal, and tablet PC. Furthermore, the information sharing system may include an application download server 130.

Another example of the present disclosure provides an apparatus and method for sharing information between the first terminal 110 and the second terminal 120. At least one application may be installed in the first terminal 110. The application may be installed by receiving application installation information from application download server 130. If an application installed in first terminal 110 is to be shared with the second terminal 120, the first terminal 110 may transmit information associated with the application installed therein to the second terminal 120 through a network. The second terminal 120 may generate a configuration file based on the information received from the first terminal 110. Further, the second terminal 120 may generate an icon based on the configuration file.

Subsequently, if the icon is selected at a time desired by a user, the second terminal 120 identifies whether an execution file corresponding to the icon is found in the second terminal 120, and may connect to the application download server 130, if it is not found. The second terminal 120 may search for installation information based on a configuration file, and may receive the information from the application download server 130.

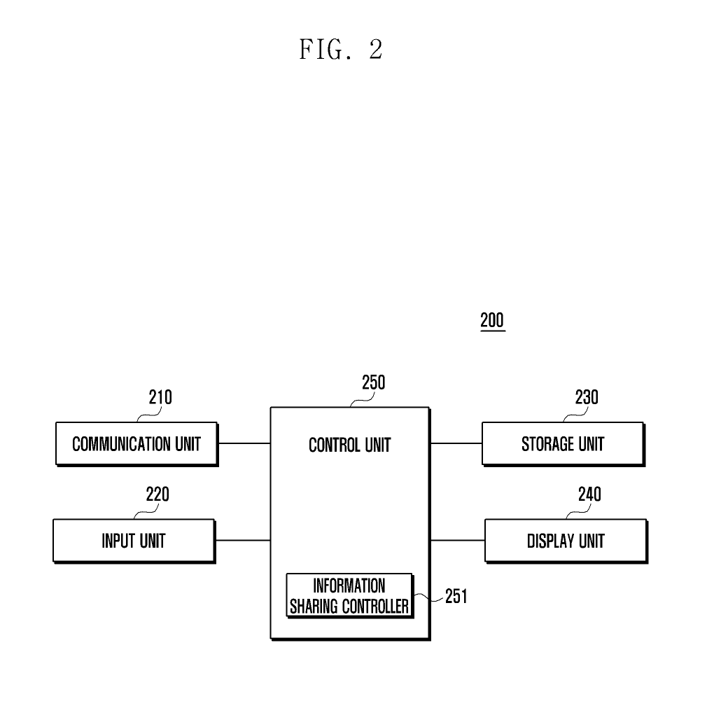

FIG. 2 is a block diagram illustrating an example configuration of a terminal in accordance with aspects of the present disclosure. Terminal 200 may include a communication unit 210, input unit 220, storage unit 230, display unit 240, and control unit 250.

The communication unit 210 may include at least one communication module for communicating with another terminal or a server. In more detail, the communication unit 210 transmits and receives a wireless signal with at least one of other terminals or server through a mobile communication network. The wireless signal may include a voice signal, video telephony signal, and data in various forms in accordance with a message transmission of characters and multimedia. Further, the communication unit 210 may exchange data with an external device by using communication technologies such as a WLAN (Wireless LAN), Wi-Fi, Wibro (Wireless broadband), Wimax (World Interoperability for Microwave Access), and HSDPA (High Speed Downlink Packet Access).

In one example, the communication unit 210 receives application installation information by communicating with the application download server under the control of control unit 250. Further, the communication unit 210 may transmit and receive the application sharing information by communicating with another terminal.

The input unit 220 may detect user input and may transmit an input signal corresponding to the user input to control unit 250. The input unit 220 may be configured by including a keypad, dome switch, touchpad (pressure sensitive/capacitive), jog wheel, jog switch, finger mouse, and/or wheel. The input unit 220 may operate as an input screen by forming a layer structure with the display unit 240. For example, the input unit 220 may include an input pad having a touch sensor and configured with a TSP (“Touch Screen Panel”) combined with the display unit 240. The input unit 220 configured by forming a layer structure with a display unit is called touchscreen. The input unit 220 may generate a control signal including at least one of signals related to a location of detected input, input means, and type of input, and transmit them to the control unit 250.

In one example, the input unit 220 may detect commands for sharing terminal information and transmitting a request for an approval. Further, input unit 220 may detect command input for receiving installation information using a configuration file and to associate an icon with the application based on the configuration file.

The storage unit 230 stores programs and commands for supporting the information sharing of the terminal. The control unit 250 controls to execute a program or a command stored in the storage unit 230. In another example, the storage unit 230 may store commands for processing information sharing. Further, the storage unit 230 may store a service daemon program for transmitting the shared information, installation information for each application, and terminal setting information. Further, the storage unit 230 may store connection information with a server in order to download an application.

The display unit 240 displays an operating state of the terminal. The display unit 240 may display information corresponding to an application, program, or service currently operating in the terminal together with a UI (User Interface) or a GUI (Graphic User Interface).

In a further example, the display unit 240 displays an App icon and an application including sharing information. If the application sharing information is received from another terminal, the display unit 240 may display an App icon corresponding to the received information. In this case, the displayed icon may be a dummy icon which may be displayed in a different form from normal icons. The dummy icon may be displayed when an application execution file is not found in the terminal. The dummy icon and a displaying method thereof will be described later in more detail.

The control unit 250 controls each component and each unit of the terminal 200 for general operations of the terminal 200. Control unit 250 may comprise at least one processor. In another example, Control unit 250 may comprise an application specific circuit (ASIC). The control unit 250 controls the communication unit 210, input unit 220, storage unit 230, and display unit 240 in accordance with a user input or a predetermined mechanism.

In another example, the control unit 250 may include an information sharing controller 251. In a further example, the information sharing controller 251 of a transmitting terminal may select at least one application, generate sharing information including an icon and an identifier (“App Id”) for the selected application, and may transmit the generated sharing information to another terminal.

The information sharing controller 251 may generate the sharing information by reading the App icon and App Id from a manifest file at an installation path of the selected application. Further, the information sharing controller 251 may generate folder sharing information by selecting a folder and combining it with the application sharing information corresponding to an icon included in the folder.

In a receiving terminal, the information sharing controller 251 may receive sharing information of at least one application from another terminal; generate a configuration file corresponding to the sharing information; display a dummy icon corresponding to the configuration file; and transmit a request for application installation information corresponding to an identifier included in the configuration file, when the dummy icon is selected.

Furthermore, the information sharing controller 251 may control the display unit 240 to display the dummy icon with a transparency different than that of other icons so that the dummy icon can be distinguished from the other icons, or displaying an indicator with the dummy icon.

In another example, the information sharing controller 251 may identify a selected icon as a normal icon, when an execution file associated with the identifier in the configuration file is found; and may identify the selected icon as the dummy icon, when the execution file associated with the identifier in the configuration file is not found.

In a further example, the sharing information may comprise folder sharing information combined with application sharing information corresponding to a folder and an icon included in the folder. The dummy icon may correspond to the folder containing the application.

In another aspect, the sharing information may comprise at least one configuration file of the application such that the dummy icon corresponds to the configuration file. The request may comprise a request signal for checking a compatibility between an operating system and the application.

In a further aspect, the information sharing controller 251 may identify a location of an execution icon associated with the application being installed through the dummy icon.

Although control unit 250 and information sharing controller 251 are illustrated as separate operating blocks, it is understood that this is merely for ease of illustration and that control unit 250 and information sharing controller 251 may be arranged as one block. For example, control unit 250 may also perform the functions of information sharing controller 251.

Furthermore, it is understood that the components of the terminal, such as communication unit 210, input unit 220, storage unit 230, display unit 240, control unit 250 are also illustrative and that the configuration of the terminal is not limited to the above example, such that many variations may be applied to the configuration of the terminal

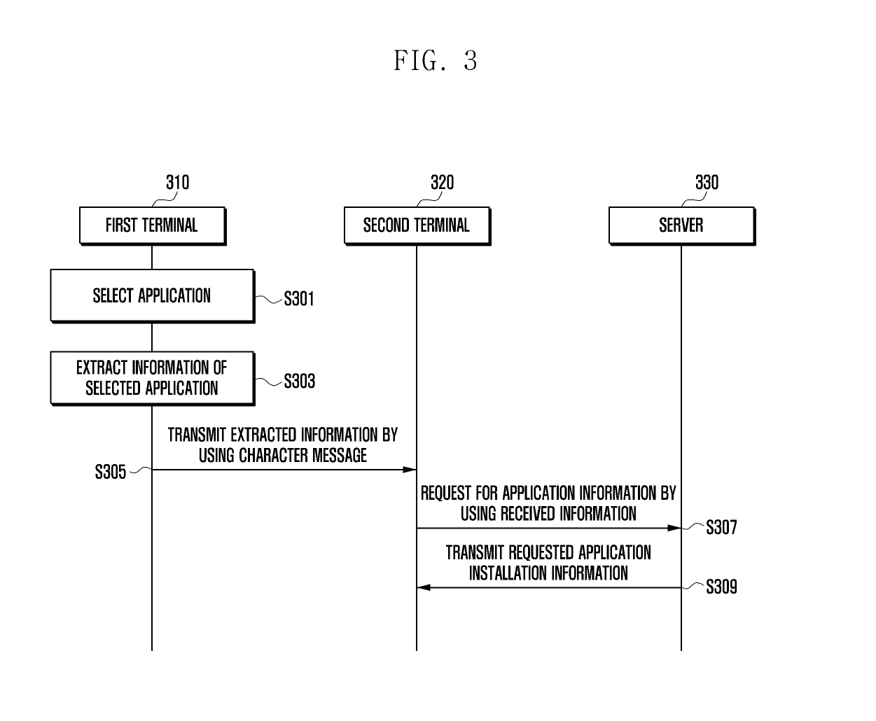

FIG. 3 is a flow chart illustrating an example information sharing method in accordance with aspects of the present disclosure. At least one application installed in a first terminal 310 may be selected and a sharing command input may be detected for the selected application at operation S301. The control unit of first terminal 310 extracts an application download URL in response to the sharing command at operation S303. The control unit transmits the extracted URL information to second terminal 320 so as to share the information by using a character message or a messenger at operation S305.

If the URL is selected in second terminal 320, the second terminal 320 may connect to an application download server 330 at operation S307. The URL information may allow second terminal 320 to download the selected application. Accordingly, application installation information may be received from a web page connected through the URL in accordance with a user's command at operation S309.

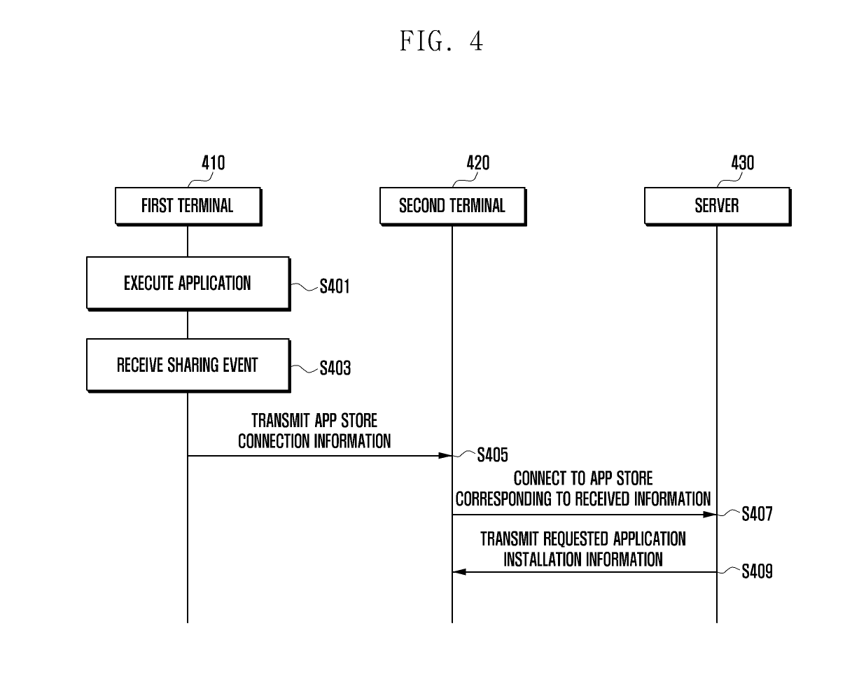

FIG. 4 is flow chart illustrating an example method for sharing information of an application in accordance with aspects of the present disclosure. At least one application may be executing in a first terminal 410 at operation S401. A sharing event may be input or received while executing the specific application at operation S403. Namely, the sharing event may be actively input in first terminal 410 to share an application with a second terminal 420, or the second terminal 420 may send a request to first terminal 410 for an application. For example, the sharing event may be requested by operating one of the first terminal 410 and second terminal 420 as an NFC reader and operating the other as an NFC tag.

If the sharing event is identified, the first terminal 410 transmits connection information of the application download server 430 to the second terminal 420 at operation S405. The connection information may be URL information. The second terminal 420 connects to the application download server 430 corresponding to the received information at operation S407. Further, the second terminal receives installation information of the corresponding application in accordance with a user's request at operation S409.

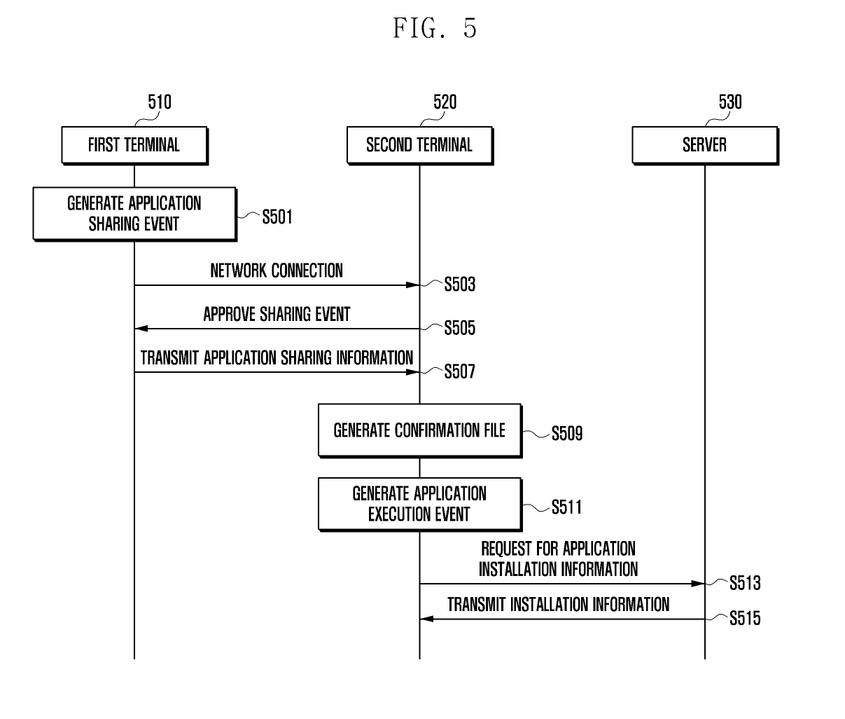

Hereinafter, referring to FIGS. 5 to 9, an example method for sharing information is described.

FIG. 5 is a flow chart illustrating another example method for sharing an application in accordance with aspects of the present disclosure. An application sharing event may be generated for at least one application installed in a first terminal 510 at operation S501. The first terminal 510 and a second terminal 520 may be connected through a network at operation S503. The network connection may be established in advance of operation S501. The first terminal 510 receives a sharing event approval message from the second terminal 520 at operation S505. The first terminal 510 configures application sharing information including an App Id and an App icon, and transmits it to the second terminal 520 at operation S507.

The second terminal 520 receives configuration information related to the application and generates a configuration file corresponding to the received information at operation S509. Further, the second terminal 520 may generate an App icon corresponding to the generated configuration file. An application execution event corresponding to the generated icon may be detected at operation S511. If the application execution event is detected, the second terminal 520 may request the application from application download server 530 at operation S513. From an application download web page, installation information of a corresponding application may be downloaded at operation S515.

Hereinafter, operations of each terminal in FIG. 5 are described in more detail.

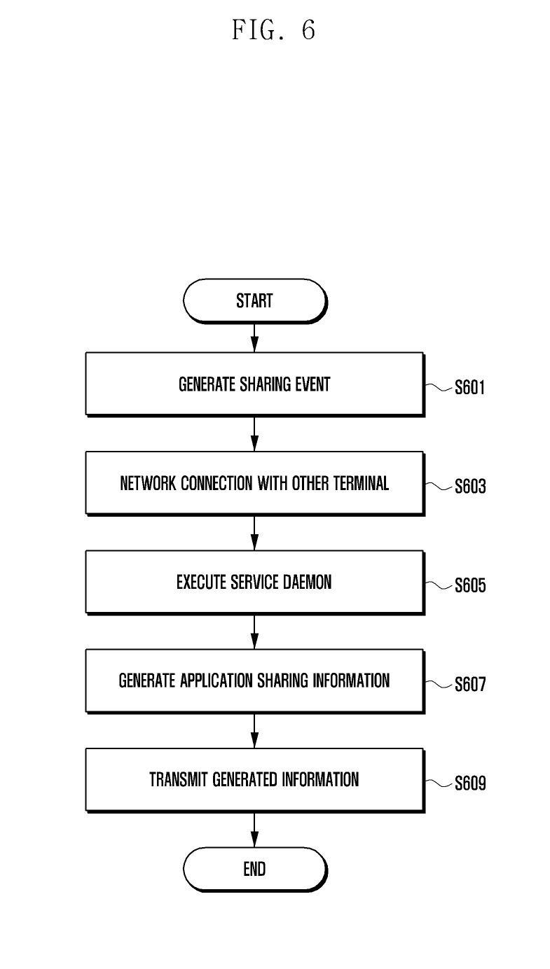

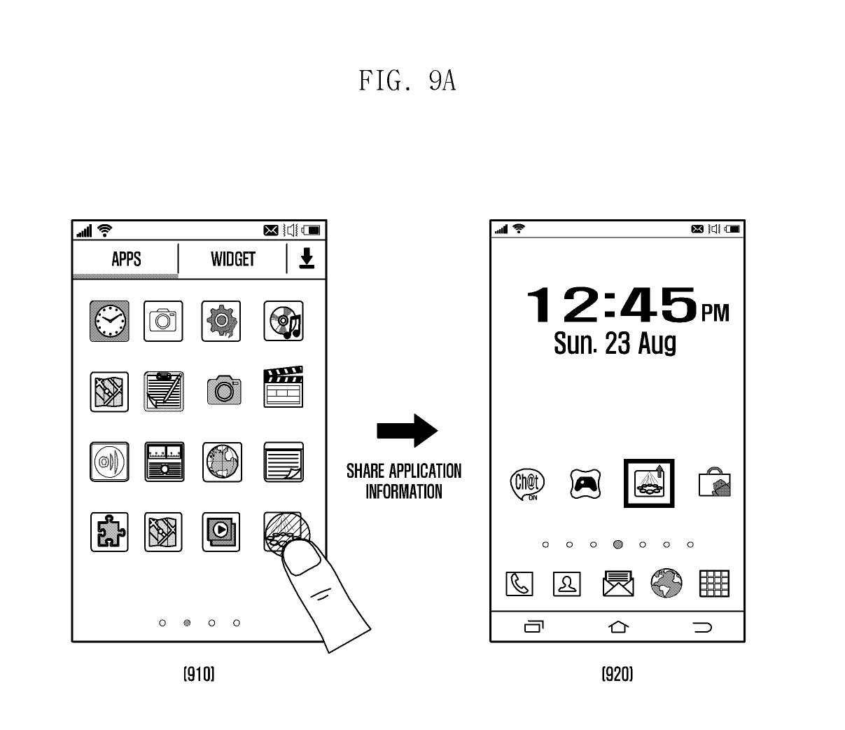

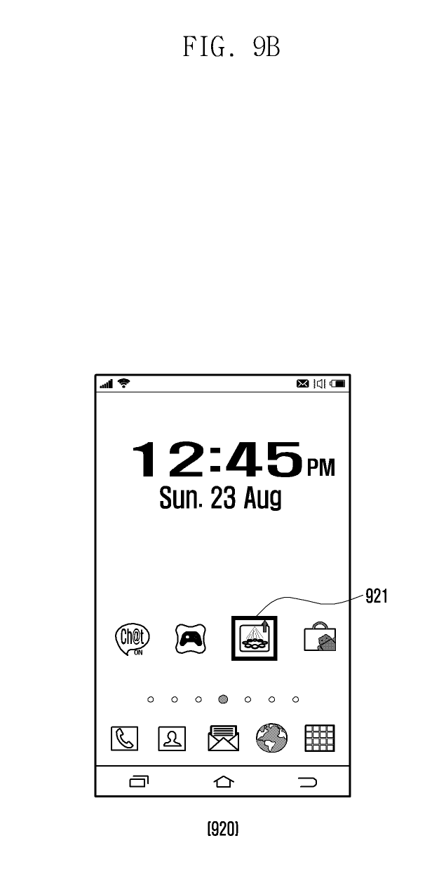

FIG. 6 is a flow chart illustrating an example method of the first terminal shown in FIG. 5. An application information sharing event input may be detected in the first terminal at operation S601. The first terminal detects the sharing event in accordance with a predetermined method. For example referring to FIG. 9A, a long touch of an App icon may be set as a sharing event for at least one application displayed in the terminal. In another example, detecting the input of a predetermined shape on the icon may be considered a sharing event request input.

The detection of a sharing event may include detection of a plurality of command inputs for a plurality of applications. In this case, download information associated with each selected application may be accumulated. Sharing information may be generated for the plurality of applications and the terminal may share the plurality of applications. When a folder is selected for sharing, the folder and at least one application included in the folder are identified as a sharing event and the following operation may be performed for sharing the applications.

When the sharing event is detected, the first terminal and second terminal may be connected through a network at operation S603. The network may include a mobile communication network and a wireless local area network. In one example, the network may be a wireless local area network including a NFC (Near Field Communication), BT (Bluetooth), and Wi-Fi. The first terminal and second terminal may transmit and receive application sharing information through the network connection.

It is understood that network connection does not have to occur after the sharing event input is detected. The first terminal and second terminal may be connected before or after the sharing event input is detected. For example, the network connection may be performed after generating application sharing information in the first terminal. Also, the network connection may be made at any time before the time of transmitting the application sharing information.

In one example, one of the first terminal and second terminal may be an NFC reader and the other may be an NFC tag. In this case, the wireless local area network may be formed by tagging. Further, the tagging operation may be performed by including an approval of application information sharing.

If the application information sharing event is generated, the control unit of the first terminal executes a service daemon at operation S605. The service daemon may be a program for generating the application sharing information. By using application installation information included in the first terminal, the service daemon generates application sharing information to be processed by a program or processor of the second terminal at operation S607. When a plurality of applications is selected, the application sharing information may be generated for the plurality of applications. When a folder is selected, the application sharing information may be generated for the folder and applications included in the folder. The service daemon generates the application sharing information to be transmitted to the second terminal by reading an App Id, App Name, and App icon from a manifest file at an application installation path of the selected application. When installation information of the corresponding application (e.g., information associated with the application server) is stored in the manifest file, it may also be transmitted to the second terminal, and the manifest file may be a file for storing application information in the terminal. The manifest file may be a file for storing installation information of an application. For example, the manifest file may include information of a corresponding application such as Net Framework assemblies, version, and dependency. The App Id may be specific information for identifying each application.

Referring to FIG. 9A, the first terminal may transmit the generated application sharing information to the second terminal at operation S609. In order to generate application sharing information for transmission to the second terminal, the first terminal may receive transmission approval information from the second terminal at a specific time in advance of the transmission.

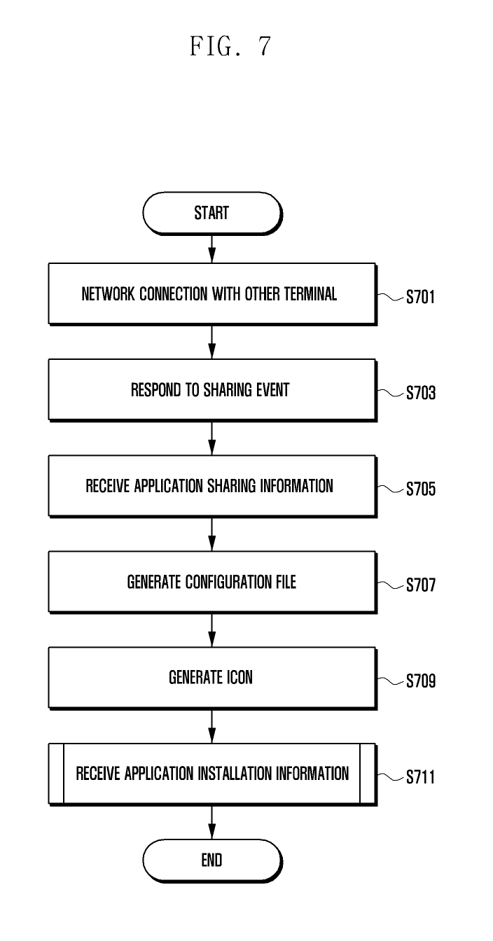

FIG. 7 is a flow chart illustrating an example method of the second terminal shown in FIG. 5. The second terminal may be connected to the first terminal through a network at operation S701. When an application sharing request is received from the first terminal, the second terminal may transmit a response to the request at operation S703. For example, if the network connection is formed through an NFC network, the network connection and the response for the application sharing operation may be made by a tagging operation.

If the first terminal transmits application sharing information of at least one application based on the response from the second terminal, the second terminal may receive it at operation S705. When the application sharing information is received, the service daemon of the second terminal may generate a configuration file. The configuration file may be generated based on the received information at operation S707, and may be configured with information including an App Id and an App icon stored in the received information. Further, the service daemon may generate a dummy icon corresponding to the generated configuration file and may displays it in the display unit at operation S709. When only one application is shared, one dummy icon corresponding to the one application may be generated and displayed. When a plurality of applications are shared, a plurality of dummy icons corresponding to each application may be generated and displayed. When a folder is shared, a dummy folder icon may be displayed, and each dummy icon corresponding to at least one application included in the shared folder of the first terminal may be displayed.

In another example, the operations of the terminal may performed differently, if the application shared with the first terminal is already installed in the second terminal. In this instance, the second terminal may check the App Id of the received sharing information, and may terminate the application information sharing operation, when an application corresponding to the App Id of the received sharing information is already installed in the second terminal.

The dummy icon may be distinguished from normal icons, and assigned to a file generated based on a configuration file of the application sharing information. The dummy icon may be displayed by distinguishing from the normal icons, because it is not an icon displayed using conventional application installation methods. For example, the dummy icon may be displayed by adjusting the transparency or may be displayed with an indicator in order to distinguish from the normal icons.

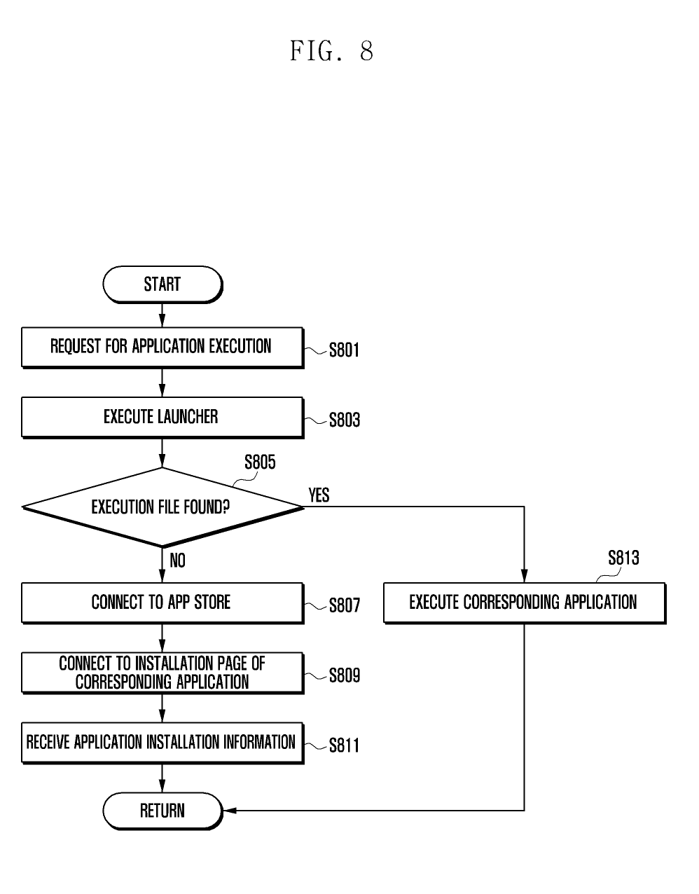

Subsequently, the second terminal receives the corresponding application installation information by selecting the generated dummy icon at operation S711. Hereinafter, the operation S711 is described in more detail referring to FIG. 8.

FIG. 8 is a flow chart illustrating an example method of installing an application.

Normal icons and a dummy icon may be displayed in the display unit of the second terminal in accordance with the procedure of FIG. 7. Referring to FIG. 9B, a dummy icon 921 may be displayed by distinguishing it from the normal icons. In this example, the dummy icon may be marked with an arrow to distinguish it from the normal icons.

An icon may be selected from a plurality of icons displayed in the screen of the second terminal and a request for executing an application may be input corresponding to the selected icon at operation S801. In addition, the dummy icon may be moved. If the icon is selected, the control unit of the second terminal activates an application execution launcher at operation S803. The launcher may execute the corresponding application by searching an execution file of the corresponding icon.

When the dummy icon is moved, an execution or a normal icon of the application installed through the dummy icon may displayed in place of the dummy icon. This allows the icon of the application to be installed and displayed at a location desired by a user. That is, when a specific icon is selected, the launcher may read an App Id from a configuration file of the corresponding icon. By using the App Id, an execution file registered in the terminal and connected to the App Id may be found, and the application may operate using its execution file, if the execution file of the corresponding icon is found. When the execution file is not found, the execution of the application may be terminated.

If the execution file connected to the App Id of the corresponding icon is found at operation S805, the corresponding application may be executed at operation S813. On the other hand, if the execution file connected to the App Id of the corresponding icon is not found at operation S805, the terminal may connect to the application download server (e.g., an App store) at operation S807.

The second terminal may be connected to a download web page of a corresponding application based on the application sharing information received from the first terminal at operation S809. The second terminal connected the application download server (or App store) at operation S807 may be connected to the download web page of the corresponding application using an App Id. If connected to the download web page, the second terminal may download installation information of the corresponding application. The download may be performed automatically, in accordance with a setting, or by a user's selection.

The application information of the first terminal may be shared with the second terminal in the above method. In particular, the second terminal may request for the installation of the corresponding application and receive it by using an App Id in lieu of URL information.

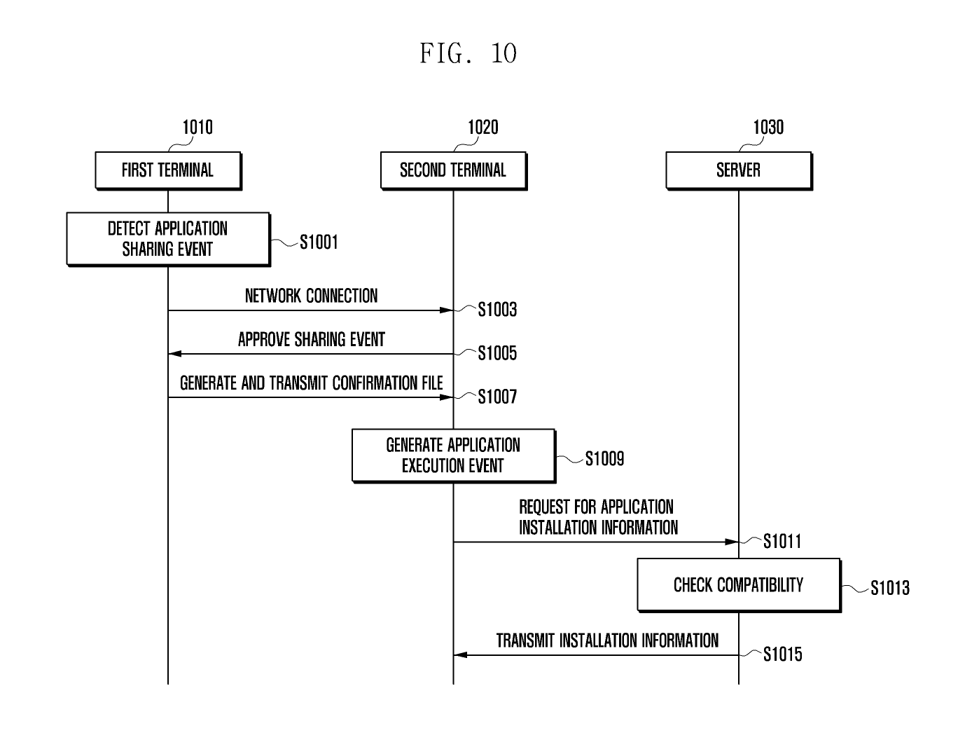

FIG. 10 is a flow chart illustrating an example method of executing an application FIG. 10 illustrates an example of generating a configuration file differently from the example of FIG. 5. Namely, FIG. 5 illustrates a method of generating a configuration file by the second terminal that received application sharing information. However, FIG. 10 illustrates a method of transmitting a configuration file generated by the first terminal 1010 to the second terminal 1020.

If a request for sharing an application is detected at operation S1001, the first terminal 1010 may be connected to the second terminal 1020 through a network at operation S1003, and may receive an application sharing approval from the second terminal 1020 at operation S1005. Subsequently, the configuration file to be transmitted to the second terminal may be generated by reading an App Id, App Name, and App icon from a manifest file of a selected application. The first terminal transmits the generated configuration file to the second terminal at operation S1007. Contrary to the example in FIG. 5, the second terminal doesn't generate a separate configuration file after receiving application sharing information from the first terminal, since the second terminal receives the configuration file from the first terminal. The second terminal may generate a corresponding dummy icon by using the received configuration file.

If an application execution event is generated and an execution file associated with an App Id is found at operation S1009, the corresponding application may be executed. However, when the execution file associated with the App Id is not found at operation S1009, the second terminal may be connected to an application download server at operation S1011.

In the example of FIG. 10, an application compatibility check may be required. In FIG. 5, the compatibility check is not necessary, since the configuration file is generated by the second terminal. However, in the example of FIG. 10, the first terminal 1010 transmits the generated configuration file to the second terminal 1020. Thus, the OS of second terminal 1020 may be incompatible with the OS of the first terminal 1010.

The server 1030 may connect second terminal 1020 to a web page from which second terminal 1020 may download a compatible version of the selected application, at operation S1013. In this case, the second terminal 1020 may transmit a request signal to the application download server so that a compatible application web page may be found.

If the download web page is connected to, second terminal 1020 may download installation information associated with the application. The download may be performed automatically, in accordance with a setting, or by a user's selection at operation S1015.

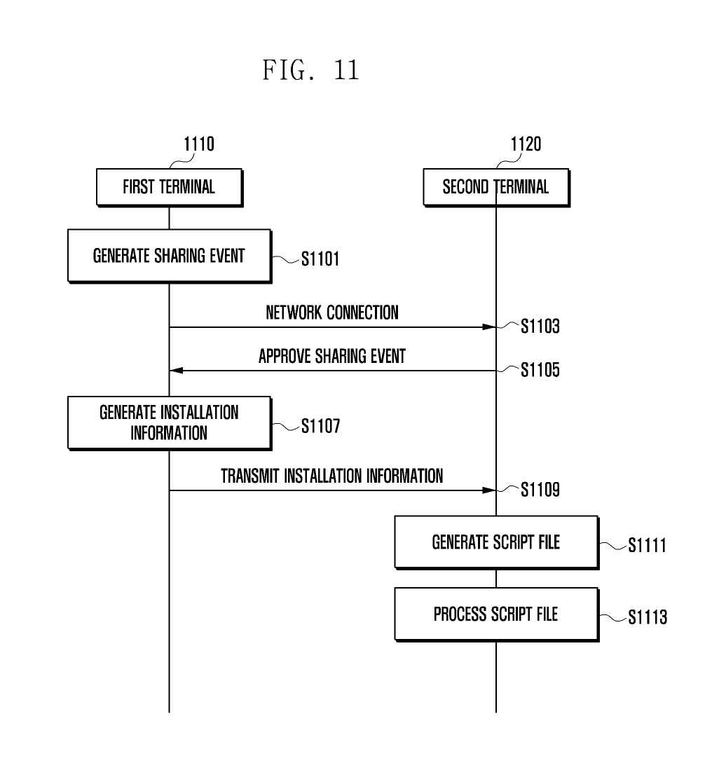

FIG. 11 is a flow chart illustrating an example method of sharing setting information in accordance with aspects of the present disclosure. In this example, not only application information but also setting information of a terminal may be shared with another terminal. The setting information of the terminal may contain a general setting menu of the terminal, such as network setting information, screen configuration information, and sound information.

An example of sharing Wi-Fi setting information is described in FIG. 11. A request for sharing setting information may be input in the first terminal 1110 at operation S1101. The first terminal 1110 connects to the second terminal 1120 at operation S1103, and receives an approval for sharing setting information from second terminal 1120 at operation S1105. The process of sharing approval may be identical to the method described in FIG. 5.

The first terminal 1110 generates Wi-Fi setting information of the first terminal at operation S1107. The Wi-Fi setting information may include a network name and a network password. The second terminal 1120 receives the setting information from the first terminal 1110 at operation S1109 and generates a script file by using the setting information at operation S1111. The second terminal 1120 applies the setting information of the first terminal by reading the setting information from the script file at operation S1113.

Furthermore, the setting information may support backup and restore functions in real time. Second terminal 1120 may backup or store previous setting information before applying the new setting information received from first terminal 1110. The second terminal may use the backup information to restore its setting information when necessary.

Advantageously, a method for sharing information between terminals may be provided. In that regard, the usability of shared data may be improved by dynamically generating installation information. That is, the usability of information may be improved because information associated with a plurality of applications or a folder may be shared. In turn, an application may be installed in a desired location of a receiving terminal in accordance with a user's request. Furthermore, not only application information but also setting information may be shared.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

What is claimed is:

1. A method for sharing information in a terminal, the method comprising:
selecting at least one application;
generating sharing information including an icon and an identifier associated with the selected application; and
transmitting the generated sharing information to at least another terminal.

2. The method of claim 1, wherein generating the sharing information comprises reading the icon and the identifier from an installation information file of the selected application.

3. The method of claim 1, further comprising:
selecting a folder, and
generating folder sharing information in conjunction with the sharing information, the folder sharing information corresponding to the folder and each icon included in the folder.

4. An apparatus for sharing application information, the apparatus comprising:
at least one processor to
exchange data with another terminal using a communication unit;
select at least one application;
generate sharing information including an icon and an identifier associated with the selected application; and
transmit the generated sharing information to at least one other terminal.

5. The apparatus of claim 4, wherein to generate the sharing information the at least one processor to further read the icon and the identifier from an installation information file of the selected application.

6. The apparatus of claim 4, wherein the at least one processor to further:
select a folder;
generate folder sharing information such that the sharing information comprises the folder sharing information, the folder sharing information corresponding to the selected folder containing the icon.

7. A method for sharing application information in a terminal, the method comprising:
receiving sharing information of at least one application from another terminal;
generating a configuration file corresponding to the sharing information;
displaying a dummy icon corresponding to the configuration file; and
transmitting a request for application installation information corresponding to an identifier included in the configuration file, when the dummy icon is selected.

8. The method of claim 7, wherein the configuration file further comprises icon information, the dummy icon indicating that an execution file associated with the identifier in the configuration file is not found.

9. The method of claim 7, wherein displaying the dummy icon comprises displaying the dummy icon with a transparency different than that of other icons so that the dummy icon can be distinguished from the other icons, or displaying an indicator with the dummy icon.

10. The method of claim 7, further comprising:
identifying a selected icon as a normal icon, when an execution file associated with the identifier in the configuration file is found; and
identifying the selected icon as the dummy icon, when the execution file associated with the identifier in the configuration file is not found.

11. The method of claim 7, wherein the sharing information comprises folder sharing information combined with application sharing information corresponding to a folder and an icon included in the folder, the dummy icon corresponding to the folder containing the application.

12. The method of claim 7, wherein the sharing information comprises at least one configuration file of the application such that the dummy icon corresponds to the configuration file, the transmitted request comprising a request signal for checking a compatibility between an operating system and the application.

13. The method of claim 7, further comprising:
determining a location of an execution icon associated with the application being installed through the dummy icon.

14. An apparatus for sharing application information in a terminal, the apparatus comprising:
at least one processor to:
exchange data with another terminal and an application download server;
display at least one icon and an operating state;
detect receipt of sharing information for at least one application from another terminal;
generate a configuration file corresponding to the sharing information;
display a dummy icon corresponding to the configuration file; and
request installation of an application corresponding to an identifier included in the configuration file, when the dummy icon is selected.

15. The apparatus of claim 14, wherein the configuration file further includes icon information, the dummy icon indicating that an execution file associated with the identifier in the configuration file is not found.

16. The apparatus of claim 14, wherein the at least one processor to further display the dummy icon with a transparency different than that of other icons so that the dummy icon can be distinguished from the other icons, or displaying an indicator with the dummy icon.

17. The apparatus of claim 14, wherein the at least one processor to further
identify a selected icon as a normal icon, when an execution file associated with the identifier in the configuration file is found; and
identify the selected icon as the dummy icon, when the execution file associated with the identifier in the configuration file is not found.

18. The apparatus of claim 14, wherein the sharing information comprises folder sharing information combined with application sharing information corresponding to a folder and an icon included in the folder, the dummy icon corresponding to the folder containing the application.

19. The apparatus of claim 14, wherein the sharing information comprises at least one configuration file of the application such that the dummy icon corresponds to the configuration file, the request comprising a request signal for checking a compatibility between an operating system and the application.

20. The apparatus of claim 14, wherein the at least one processor to further identify a location of an execution icon associated with the application being installed through the dummy icon.
